(19) United States
(12) Patent Application Publication
(10) Pub. No.: US 2021/0241527 A1
(43) Pub. Date: Aug. 5, 2021

(54) POINT CLOUD GENERATION METHOD AND SYSTEM, AND COMPUTER STORAGE MEDIUM

(71) Applicant: SZ DJI TECHNOLOGY CO., LTD., Shenzhen (CN)

(72) Inventors: Chunmiao SUN, Shenzhen (CN); Jiabin LIANG, Shenzhen (CN)

(73) Assignee: SZ DJI TECHNOLOGY CO., LTD., Shenzhen (CN)

(21) Appl. No.: 17/233,536

(22) Filed: Apr. 18, 2021

Related U.S. Application Data
(63) Continuation of application No. PCT/CN2019/080171, filed on Mar. 28, 2019.

(51) Int. Cl. G06T 17/20; G06T 7/55; G06K 9/62

(52) U.S. Cl. CPC G06T 17/20; G06T 7/55; G06T 2207/20076; G06T 2207/20224; G06K 9/6215

(57) ABSTRACT

A point cloud generation method and system, and a computer storage medium are provided. The method includes: initializing a spatial parameter of each pixel in a reference image; updating the spatial parameter of each pixel through propagation of adjacent pixels; comparing the spatial parameter of each pixel after the propagation with that before the propagation to determine whether a change occurs, if a change occurs, performing classification based on differences in a depth and a score after versus before the propagation, and changing the spatial parameter within a range; calculating the score of changed spatial parameter of each pixel, and updating spatial parameters of at least some pixels to spatial parameters whose scores reach a preset threshold range; determining, based on an updated spatial parameter of each pixel, a depth map corresponding to the reference image; and generating a dense point cloud image based on the depth map.

### RELATED APPLICATIONS

This application is a continuation application of PCT application No. PCT/CN2019/080171, filed on Mar. 28, 2019, and the content of which is incorporated herein by reference in its entirety.

### TECHNICAL FIELD

The present disclosure generally relates to the field of information technologies, and more specifically, to a point cloud generation method and system, and a computer storage medium.

### BACKGROUND

Densification of a sparse point cloud is an important step of a three-dimensional reconstruction algorithm. It inherits a sparse point cloud generated in a previous step, and after accurate spatial position-attitude information of images, the sparse point cloud is densified to restore details of a scenario. It is of great significance for subsequent generation of a complete grid structure or the like. A mainstream three-dimensional reconstruction and densification algorithm includes a local patchmatch algorithm. This algorithm is a multi-view three-dimensional match algorithm that uses a reference image and a plurality of neighboring images to jointly calculate a depth map corresponding to the reference image. In the conventional patchmatch algorithm, a plurality of random values may be combined to form candidate update combinations, and a large amount of calculation is required. To save memory resources, an original image is usually downsampled by half, and then a depth map of the same size is calculated; however, plenty of details in the original image disappear consequently, and quality of the depth map deteriorates.

Therefore, how to effectively generate a dense point cloud image has become a technical problem to be resolved urgently.

### SUMMARY

The present disclosure is proposed to resolve at least one of the foregoing problems. Specifically, one aspect of the present disclosure provides a point cloud generation method, and the point cloud generation method includes: initializing a spatial parameter of each pixel in a reference image, where the reference image is an image in a two-dimensional image set obtained by photographing a target scene; updating the spatial parameter of each pixel in the reference image through propagation of the spatial parameter of each pixel to adjacent pixels in the reference image to obtain an updated spatial parameter of the pixel in the reference image; for each pixel in a reference image that a change of the spatial parameter occurs before and after the propagation: determining a first difference between a depth value of the pixel before and after the propagation and a second difference between a score of the special parameter before and after the propagation; performing classification based on the first difference and the second difference; changing the spatial parameter of the pixel within a predetermined range based on the classification; updating, based on the score of the updated spatial parameter of each pixel, spatial parameters of at least some pixels in the reference image to corresponding updated spatial parameters whose scores reach a preset threshold range; determining, based on the updated spatial parameter of each pixel in the reference image, a depth map corresponding to the reference image; and generating a dense point cloud image based on the depth map corresponding to the reference image.

In the foregoing method, the spatial parameter of each pixel after propagation is compared with that before propagation to determine whether the change occurs, and if the change occurs, classification is performed based on the differences between the depth and score after propagation and those before propagation, and the spatial parameter of each pixel is changed within the predetermined range based on different classification conditions. In this way, an amount of calculation is reduced, and a calculation speed is increased.

In addition, in the foregoing method, during score calculation, using a current pixel as a center, an image block is an image block in which a plurality of pixels spaced apart from the current pixel by at least one pixel are selected around the center pixel in the current image block. Therefore, an acquisition range of image blocks is expanded, and it is ensured that a detail effect is improved while the amount of calculation does not increase. Therefore, noise in the obtained depth map is reduced, more depth points are calculated, and the depth map is more complete and accurate. Moreover, the dense point cloud image obtained by using the foregoing method also correspondingly has less noise, more details can be displayed, and especially, there are more point clouds in a textureless region.

### BRIEF DESCRIPTION OF THE DRAWINGS

To clearly describe the technical solutions in some exemplary embodiments of the present disclosure, the following briefly describes the accompanying drawings required for describing these embodiments. Apparently, the accompanying drawings in the following description show merely some exemplary embodiments of the present disclosure, and a person of ordinary skill in the art may still derive other drawings from these accompanying drawings without creative efforts.

FIG. 1 is a schematic flowchart of a point cloud generation method according to some exemplary embodiments of the present disclosure;

FIG. 2 is a diagram showing a comparison between a conventional image block and an image block according to some exemplary embodiments of the present disclosure, where (a) is a conventional image block, and (b) is an image block according to some exemplary embodiments of the present disclosure;

FIG. 3 is a schematic diagram showing that a pixel in a neighboring image appears in a reference image according to some exemplary embodiments of the present disclosure;

FIG. 4 is a schematic flowchart of a strategy for updating a depth and a normal vector according to some exemplary embodiments of the present disclosure;

FIG. 5 is a schematic diagram showing a comparison between a depth map (right panel) obtained by applying a method according to some exemplary embodiments of the present disclosure in different scenarios and a depth map (left panel) obtained by using a conventional method;

FIG. 6 is a schematic block diagram of a point cloud generation apparatus according to some exemplary embodiments of the present disclosure; and

FIG. 7 is a schematic block diagram of a point cloud generation system according to some exemplary embodiments of the present disclosure.

### DETAILED DESCRIPTION

To make the objects, technical solutions, and advantages of the present disclosure clearer, the following describes some exemplary embodiments according to the present disclosure in detail with reference to the accompanying drawings. Apparently, the described exemplary embodiments are only a part of the embodiments of the present disclosure, rather than all the embodiments of the present disclosure. It should be understood that the present disclosure is not limited by the exemplary embodiments described herein. All other embodiments that a person skilled in the art obtains without creative efforts based on the embodiments of the present disclosure shall fall within the scope of protection of the present disclosure.

Plenty of specific details are given in the following description to allow a more thorough understanding of the present disclosure. However, it is obvious to a person skilled in the art that the present disclosure can be implemented without one or more of these details. In some examples, to avoid confusion with the present disclosure, some technical features well known in the art are not described.

It should be understood that the present disclosure can be implemented in different forms and should not be construed as being limited to the embodiments provided herein. On the contrary, these embodiments are provided to make the disclosure thorough, and fully convey the scope of the present disclosure to a person skilled in the art.

The terms used herein are only intended to describe some specific embodiments and not used as a limitation on the present disclosure. The terms “a”, “one”, and “said/the” of singular forms used herein are also intended to include plural forms, unless otherwise specified in the context clearly. It should also be understood that the terms “comprising” and/or “including”, when used in this specification, indicate presence of the described feature, integer, step, operation, element, and/or component. However, this does not exclude presence or addition of one or more other features, integers, steps, operations, elements, components, and/or groups. When used herein, the term “and/or” includes any and all combinations of related listed items.

To enable a thorough understanding of the present disclosure, a detailed structure is proposed in the following description to explain the technical solutions provided in the present disclosure. Some exemplary embodiments of the present disclosure are hereinafter described in detail. However, in addition to these detailed descriptions, the present disclosure may also have other implementations.

To resolve the foregoing technical problems, the present disclosure provides a point cloud generation method. The point cloud generation method includes: initializing a spatial parameter of each pixel in a reference image, where the reference image is any image in a two-dimensional image set obtained by photographing a target scene; updating the spatial parameter of each pixel in the reference image by using propagation of adjacent pixels; comparing the spatial parameter of each pixel after propagation with that before the propagation to determine whether a change occurs, and if the change occurs, performing classification based on differences between a depth and a score after the propagation and those before the propagation, and changing the spatial parameter of each pixel within a predetermined range based on different classification conditions; updating, based on a score of a changed spatial parameter of each pixel, spatial parameters of at least some pixels to spatial parameters whose scores reach a preset threshold; determining, based on an updated spatial parameter of each pixel in the reference image, a depth map corresponding to the reference image; and generating a dense point cloud image based on the depth map corresponding to the reference image.

By using the foregoing method, the amount of calculation may be reduced, the calculation speed is increased, noise in the obtained depth map is reduced, more depth points are calculated, and the depth map is more complete and accurate. The obtained dense point cloud image also correspondingly has less noise, more details can be displayed, and especially, there are more points in a point cloud corresponding to a textureless region.

The point cloud generation method of this disclosure is hereinafter described in detail with reference to the accompanying drawings. Under a condition that no conflict occurs, the following embodiments and features thereof may be combined.

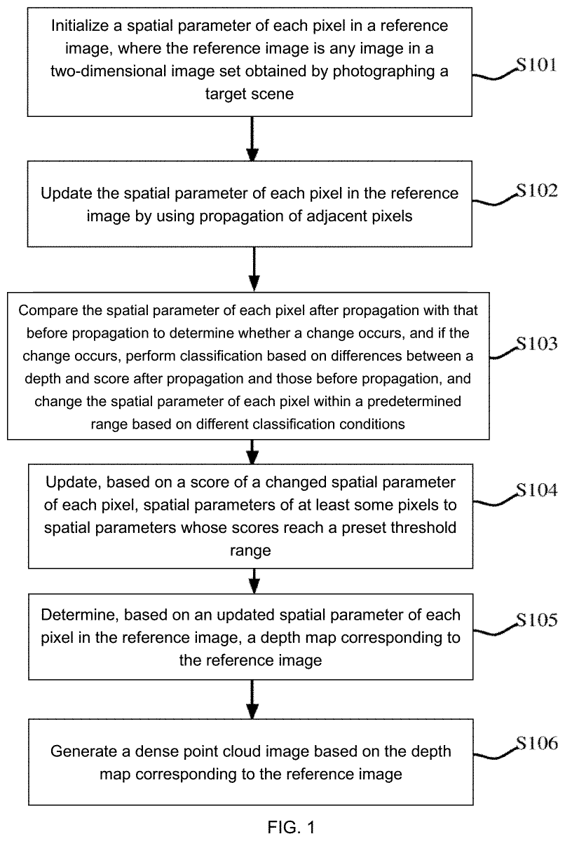

In some exemplary embodiments, as shown in FIG. 1, first, step S101 is to initialize a spatial parameter of each pixel in a reference image, where the reference image is any image in a two-dimensional image set obtained by photographing a target scene. Further, the spatial parameter includes at least a depth value and a normal vector of a three-dimensional spatial point corresponding to a pixel.

The two-dimensional image set may be an image set obtained by performing multi-angle photographing on the target scene or a target object. A photographing device that shoots the two-dimensional image set is not limited in the present disclosure, and may be any photographing device, for example, a camera. In an example, the photographing device may be a photographing device on an unmanned aerial vehicle.

In some exemplary embodiments of the present disclosure, for any image (represented as a reference image) in the two-dimensional image set, a processing granularity is pixel-level, that is, each pixel in the reference image is processed.

In step S101, the spatial parameter of each pixel in the reference image is initialized. To be specific, initialization processing is first performed on each pixel in the reference image to obtain an initial value of the spatial parameter of each pixel, to facilitate subsequent updating and further obtain a final value of the spatial parameter of each pixel.

The spatial parameter of the pixel may be used for generating a depth map. Therefore, the spatial parameter may include at least a depth of the three-dimensional spatial point corresponding to the pixel.

In some exemplary embodiments, the spatial parameter may include the depth of the three-dimensional spatial point corresponding to the pixel and the normal vector of the three-dimensional spatial point. On a basis of the normal vector of the three-dimensional spatial point in addition to the depth of the three-dimensional spatial point corresponding to the pixel, a dense point cloud image subsequently generated or a three-dimensional map further generated may be more accurate.

In some exemplary embodiments of the present disclosure, the following manner may be used to initialize the spatial parameter of each pixel in the reference image:

generating a sparse point cloud image based on the two-dimensional image set; and initializing the spatial parameter of each pixel in the reference image based on the sparse point cloud image.

Specifically, the sparse point cloud image may be used for the initialization processing of the spatial parameter of each pixel in the reference image. An existing suitable technology may be used to generate the sparse point cloud image based on the two-dimensional image set. For example, the sparse point cloud image may be generated by using a Structure from Motion (SfM) method. This is not specifically limited herein.

Since the points in the sparse point cloud image are sparse, many pixels may not have their direct corresponding points in the sparse point cloud image. In such a case, a Gaussian distribution mode may be used for the initialization processing.

In some exemplary embodiments, for a current pixel in the reference image, a Gaussian distribution using a reference point in the sparse point cloud image as a center is used to initialize a spatial parameter of the current pixel, where a pixel corresponding to the reference point is closest to the current pixel. In other words, a reference point is selected for each pixel, where a pixel corresponding to the reference point is closest to that pixel, and the Gaussian distribution using the reference point as a center is used to initialize the spatial parameter of the current pixel.

The manner of initializing the spatial parameter of the pixel based on the sparse point cloud image may be used for a reference image selected from the two-dimensional image set. If a depth map corresponding to a previous image selected from the two-dimensional image set has been obtained, the initialization processing may be performed on a next image directly based on the depth map.

The foregoing initialization method is described only as an example, and other methods known to a person skilled in the art are also applicable to the present disclosure.

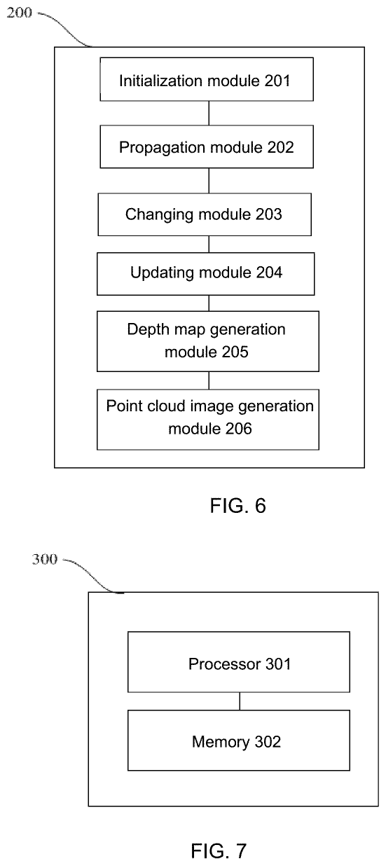

FIG. 1 is a schematic flowchart of a point cloud generation method according to some exemplary embodiments of the present disclosure. The method may be executed by a point cloud generation apparatus 200, as shown in FIG. 6, or a point cloud generation system 300, as shown in FIG. 7, of the present disclosure. For example, the method may be stored as a set of instructions in a storage medium of the point cloud generation apparatus 200 or the point cloud generation system 300. A processor of the point cloud generation apparatus 200 or the point cloud generation system 300 may, during operation, read and execute the set of instructions to perform the following steps of the method. Specifically:

Step S102 is to update the spatial parameter of each pixel in the reference image by using propagation of adjacent pixels.

After the spatial parameter of each pixel in the reference image is initialized, the spatial parameter of each pixel is updated to obtain a final value. The initialized spatial parameter may be different from the actual spatial parameter. The updating may cause the spatial parameter close to or reach the actual value (the actual value is the value of a spatial parameter corresponding to a real three-dimensional spatial point).

In some exemplary embodiments the present disclosure, the spatial parameter of each pixel in the reference image may be updated by using propagation of an adjacent pixel(s). For example, for a current pixel in the reference image (that is, a pixel to be updated currently), the spatial parameter of the current pixel may be updated based on an adjacent pixel adjacent to the current pixel. In some exemplary embodiments, the adjacent pixel may be a pixel whose spatial parameter has been updated.

In other words, each pixel in the reference image may be updated based on a spatial parameter of a pixel that is adjacent to the pixel and has been updated.

In an example, the direction of propagation of an adjacent pixel(s) may include: from left to right of the reference image, and/or from right to left of the reference image.

In some exemplary embodiments, the direction of propagation of an adjacent pixel(s) may further include: from top to bottom of the reference image, and/or from bottom to top of the reference image, or another appropriate direction of propagation.

In an example, the updating may further include: calculating a score of the spatial parameter of the current pixel after propagation; and if the score after propagation reaches a preset threshold range, updating the spatial parameter of the current pixel to a spatial parameter after propagation. Based on a trend of the score value, if the preset threshold range is reached, the spatial parameter of each pixel may be updated. In a specific example, the preset threshold may be in a positive correlation with a score difference. In some exemplary embodiments, the preset threshold may be in a negative correlation with a score difference. Specifically, a relationship between the preset threshold and the score difference reflects a similarity between the spatial parameter of the pixel and the actual value. For example, when the spatial parameter of the pixel is the actual value, a value of the score may be set to 0, and the farther the spatial parameter of the pixel deviates from the actual value, the larger the value of the score. Therefore, the spatial parameter of each pixel may be updated based on a trend of reducing the value of the score. Alternatively, when the spatial parameter of the pixel is the actual value, the value of the score may be set to 1, and the farther the spatial parameter of the pixel deviates from the actual value, the smaller the value of the score. Therefore, the spatial parameter of each pixel may be updated based on a trend of increasing the value of the score. Calculation of the score mentioned above causes the spatial parameter of each pixel to be closer or even equal to the actual value.

In an example, the method for calculating the score may include: projecting an image block adjacent to each pixel in the reference image to a neighboring image adjacent to the reference image, and calculating a similarity score between an image block in the reference image and a matching image block in the neighboring image, where using the current pixel as a center pixel, the image block is an image block in which a plurality of pixels spaced apart from the current pixel by at least one pixel are selected around the center pixel in the current image block. In a case, the image block may be a 5*5 square pixel image block, or may be a 6*6 square pixel block, or may be another appropriate square pixel block. The foregoing solution may also be described as setting the image block as an image block using the current pixel as a center and extending from the center by at least two pixels. This setting may expand an acquisition range of image blocks, so as to ensure that the amount of calculation does not increase while improving the detail effect.

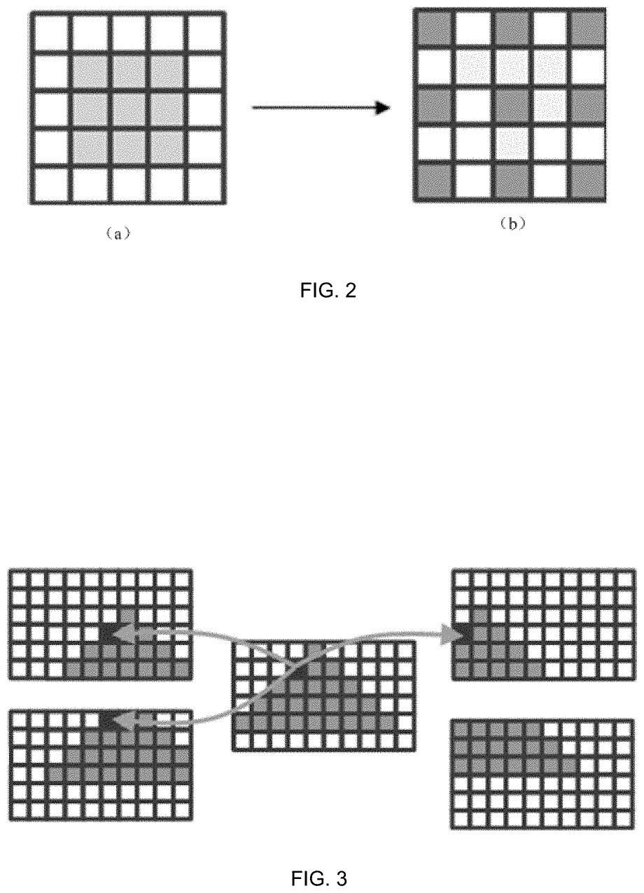

In some exemplary embodiments, as shown in FIG. 2, (a) is a conventional image block, and (b) is an image block according to some exemplary embodiments of the present disclosure. With a current pixel as a center pixel, the image block is an image block in which a plurality of pixels spaced apart from the current pixel by at least one pixel are selected around the center pixel in the current image block. For example, originally, nine pixel blocks can cover only a 3*3 image range. However, when the manner in some exemplary embodiments is used to perform a selection in a manner of spacing apart by one pixel block, the original nine pixel blocks can cover a 5*5 range. Certainly, this is an example for description only. In some exemplary embodiments, a selection may also be performed by using a spacing of two pixels, three pixels, four pixels, or the like. In these cases, an image range of 7*7, 9*9, 11*11 or the like may be covered. Certainly, excessively expanding the spacing range may cause the loss of image details. The selection in the manner of spacing apart by one pixel block can not only improve the detail effect without increasing the amount of calculation, but also prevent the loss of details due to too many pixels included in the image block.

More specifically, the calculating of the similarity score of matched image blocks between the reference image and the neighboring image may include: calculating a selection probability; and performing the calculation of the similarity score by using the selection probability to weight a matching cost, where the selection probability is a probability that each pixel in the neighboring image appears in the reference image.

During calculation of a depth map of the reference image, a plurality of neighboring images may be selected to fill a blocked part of a single neighboring image, thereby enriching details. Overlapping rates of the neighboring image and the reference image are different. Therefore, for a pixel in the reference image, using a part of the neighboring image overlapping the pixel in the calculation of depth estimate is reliable, but whether overlapping occurs is unknown before matching. Thus, each pixel in the neighboring image is tagged with 0 or 1, which represents whether the pixel appears in the reference image. As shown in FIG. 3, the image in the center is a reference image, and four images around the reference image are neighboring images, where pixels of three neighboring images pointed to by arrows all appear in the reference image, but a neighboring image located in a lower right corner does not have a pixel corresponding to that pixel.

A probability that each pixel is selected is not only related to a matching cost between the pixel and a local block in the reference image, but also related to a probability that a neighboring image adjacent to the pixel can be seen. The probability that each pixel in the neighboring image appears in the reference image may be obtained based on a related mathematical operation such as a Markov state transition matrix, and may be specifically calculated based on the following formula:

$$q ( {Z}_{l} ) = \frac{1}{A} α ( {Z}_{l} ) β ( {Z}_{l} ) ,$$

where A is a normalization factor, α(Zₗ) indicates a probability that a pixel l appears in the reference image in forward propagation, and β(zₗ) indicates a probability that the pixel l appears in the reference image in backward propagation, where the forward propagation and the background propagation indicate opposite propagation directions, for example, left-to-right propagation and right-to-left propagation in which one may be backward propagation and the other is forward propagation, or top-to-bottom propagation and bottom-to-top propagation in which one may be backward propagation and the other is forward propagation, or other propagation directions that are opposite to each other.

It should be noted that the method for calculating α(Zₗ) and β(zₗ) may be any appropriate method known to a person skilled in the art, and is not specifically limited herein.

A score indicating whether an estimate of any pixel and a normal vector is accurate is obtained by weighting a corresponding matching cost. For each neighboring image, the selection probability represents a weight of a matching cost between matched image blocks, and calculation of the weight is as shown in the following formula:

$${P}_{l} ( m ) = \frac{q ( {Z}_{l}^{m} = 1 )}{{\sum }_{m = 1}^{M} q ( {Z}_{l}^{m} = 1 )} .$$

Each pixel is considered as a window supporting tilt, and may be expressed as a separate three-dimensional plane, as shown by the following formula:

dₗ=nₗ_{ₓ}lₓ+nₗ_{_{y}}l_{y}+nₗ_{_{z}}.

In the formula, (nₗ_{ₓ}, nₗ_{_{y}}, nₗ_{_{z}}) indicates a normal vector of a pixel at (lₓ, l_{y}), and dₗ indicates a depth value of the pixel l.

When the matching cost between the reference image and the neighboring image is calculated, a pairwise projection relationship between images may be used to project an image block corresponding to the center pixel in the reference image to a corresponding image block in the neighboring image, and a normalized cross-correlation value is calculated, as shown in the following formula:

xₗ^{m}=Hₗxₗ, and

Hₗ=K^{m}(R^{m}−dₗ⁻¹t^{m}nₗ^{T})K⁻¹.

When the matching cost between the reference image and the neighboring image is calculated, a homograph matrix between the reference image and the neighboring image is calculated; and the pairwise projection relationship between images is used to project an image block around each pixel in the reference image to the neighboring image to calculate a normalized cross-correlation value as a score for measuring quality of matching.

Therefore, the problem of solving a pixel depth is converted into estimating a normal vector and a depth of a plane, so that the matching cost between the reference image and the corresponding neighboring image may be minimized. An optimal depth \hat{θ}ₗ^{opt} and an optimal normal vector \hat{n}ₗ^{opt} may be selected by using the following formula:

$$( {\hat{θ}}_{l}^{o p t} , {\hat{n}}_{l}^{o p t} ) = {arg min}_{{θ}_{l}^{*} , {n}_{l}^{*}} {\sum }_{m = 1}^{M} {P}_{l} ( m ) ( 1 - {p}_{l}^{m} ( {θ}_{l}^{*} {n}_{l}^{*} ) ) .$$

The obtained depth is propagated to surrounding pixels in a predetermined direction, and a lower matching cost is used to update the depth value and the normal vector. Assuming that a random result includes correct depth and normal vector, a correct depth estimate may be obtained around the estimated pixel.

The score is calculated by using the selection probability to weight the matching cost. In comparison with the previous manner of randomly extracting images for accumulation, the amount of calculation is greatly reduced. In addition, scores of estimates of the depth and normal vector of each pixel are also more accurate, and a calculation result of the depth map is greatly improved.

It should be noted that in some exemplary embodiments, a score of a spatial parameter of a pixel that is propagated or randomly changed or updated may be calculated in accordance with the foregoing rule.

Then still as shown in FIG. 1, step S103 is to compare the spatial parameter of each pixel after propagation with that before propagation to determine whether a change occurs, and if a change occurs, perform classification based on differences in the depth and the after versus before the propagation, and change the spatial parameter of each pixel within a predetermined range based on different classification conditions.

In some exemplary embodiments, the predetermined range may include a first predetermined range and a second predetermined range, an interval of the first predetermined range is greater than an interval of the second predetermined range, and the changing of the spatial parameter of each pixel within a predetermined range may include: randomly changing within the first predetermined range and/or fluctuating within the second predetermined range.

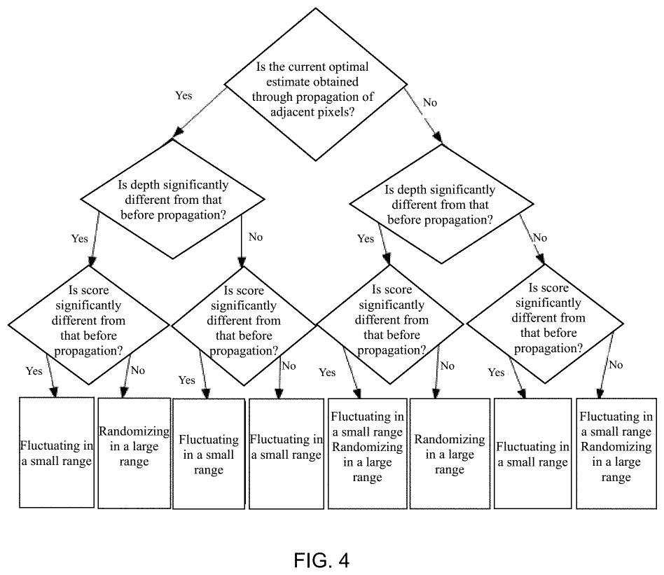

For example, FIG. 4 is a schematic flowchart of a strategy for updating a depth and a normal vector according to some exemplary embodiments of the present disclosure. The strategy may be executed by the point cloud generation apparatus 200, as shown in FIG. 6, and/or the point cloud generation system 300, as shown in FIG. 7, of the present disclosure. For example, operation steps of executing the strategy may be stored as a set of instructions in a medium of the point cloud generation apparatus 200 and/or the point cloud generation system 300. A processor of the point cloud generation apparatus 200 and/or the point cloud generation system 300 may, during operation, read and execute the set of instructions to perform the steps.

As shown in FIG. 4, randomly changing within the first predetermined range is randomly changing within a large range, and fluctuating within the second predetermined range is fluctuating within a small range.

In an example, the randomly changing of the spatial parameter of the current pixel within the first predetermined range may include: keeping a depth of the current pixel unchanged, and randomly changing a normal vector thereof within the first predetermined range; and keeping the normal vector of the current pixel unchanged, and randomly changing the depth thereof within the first predetermined range. Since the normal vector and the depth are two different values, the first predetermined range within which the normal vector is changed and the first predetermined range within which the depth is changed should be different interval ranges. These interval ranges may be set properly as needed, or a better interval range may be set based on prior experience. The first predetermined range of the normal vector and the first predetermined range of the depth are not specifically limited herein.

In an example, the fluctuating of the spatial parameter of the current pixel within the second predetermined range may include: keeping a depth of the current pixel unchanged, and fluctuating a normal vector thereof within the second predetermined range; and keeping the normal vector of the current pixel unchanged, and fluctuating the depth thereof within the second predetermined range. Since the normal vector and the depth are two different values, the second predetermined range within which the normal vector is changed and the second predetermined range within which the depth is changed should be different interval ranges. The interval range may be set properly as needed, or a better interval range may be set based on prior experience. The second predetermined range of the normal vector and the second predetermined range of the depth are not specifically limited herein.

In a conventional method for estimating the depth and normal vector of a pixel, first, the depth and the normal vector are updated by using propagation of adjacent pixels; and then the depth and the normal vector are alternately randomized by using a coordinate descent method, where the randomization process includes randomizing within a large range and fluctuating within a small range, that is, keeping the depth unchanged, randomizing the normal vector within the large range and fluctuating the normal vector within the small range, and then keeping the normal vector unchanged, and randomizing the depth within the large range and fluctuating the depth within the small range. In this way, four combinations may be formed. Corresponding scores are calculated separately, and then the depth and the normal vector are updated. Therefore, the amount of calculation is large, and the calculation speed is low.

Therefore, to resolve the foregoing problem, the present disclosure provides a strategy for accelerating calculation. The strategy includes: comparing the spatial parameter of each pixel after propagation with that before the propagation to determine whether a change occurs, and if the change occurs, performing classification based on differences in depth and score after versus before the propagation, and changing the spatial parameter of each pixel within a predetermined range based on different classification conditions. To be specific, selectively randomly changing the depth and the normal vector within a large range and fluctuating the depth and the normal vector within a small range based on a condition of propagation of the spatial parameter of each pixel to adjacent pixels can reduce the amount of calculation and reach an effect of acceleration. FIG. 4 shows a strategy made for determining whether the depth and normal vector after propagation are updated in comparison with those before propagation, and if they are updated, performing classification based on the differences between the depth and score after propagation and those before propagation.

Specifically, as shown in FIG. 4, the performing of the classification based on differences in the depth and the similarity score after versus before the propagation, and the changing of the spatial parameter of each pixel within the predetermined range based on the different classification conditions may include:

First determining whether a current optimal estimate of the spatial parameter of the current pixel is obtained through propagation of adjacent pixels, and if the current optimal estimate of the spatial parameter of the current pixel is obtained through the propagation of adjacent pixels, comparing a current depth with a depth before the propagation to determine whether a difference thereof exceeds a specified depth difference threshold, that is, determining whether the current depth differs greatly from that before the propagation; if the specified depth difference threshold is exceeded, which indicates that one of the depth after the propagation and the depth before the propagation may deviate significantly from an actual value; thus, in order to determine which one of the two values is closer to the actual value, comparing a score of the spatial parameter of the current pixel with a score thereof before the propagation to determine whether a difference thereof exceeds a specified score difference threshold; and if the specified score difference threshold is exceeded and the score is better than that before the propagation, fluctuating the spatial parameter of the current pixel within the second predetermined range, that is, performing small-range fluctuating, in this case, since the difference between the two scores is large and the score is better than that before propagation, this indicates that the depth after the propagation is closer to the actual value than the depth before the propagation, and therefore only small-range fluctuating is necessary; alternatively, if the specified score difference threshold is not exceeded, randomly changing the spatial parameter of the current pixel within the first predetermined range, that is, performing large-range randomizing; in this case, since the specified score difference threshold is not exceeded, this indicates that the difference between the two scores is not large and that the two scores may both deviate significantly from the actual value, therefore, large-range randomizing is performed in this case to estimate a depth that is more in line with the actual value.

It should be noted that in some exemplary embodiments, the specified depth difference threshold may be a depth difference threshold specified based on an actual requirement, or may be an appropriate depth difference threshold specified based on prior experience. Once the depth difference between the depth after propagation and the depth before propagation exceeds the specified depth difference threshold, it may indicate that at least one of the two depth values deviates significantly from the actual value and thus needs to be further changed and updated.

The specified score difference threshold may also be a score difference threshold specified based on an actual requirement, or may be an appropriate score difference threshold specified based on prior experience. Once the score difference between the score after propagation and the score before propagation exceeds the specified score difference threshold, it may indicate that one of the two depth values deviates significantly from the actual value. Once the score difference between the score after propagation and the score before propagation does not exceed the specified score difference threshold, it indicates that the two scores may both deviate significantly from the actual value.

Still as shown in FIG. 4, the performing of the classification based on the differences in the depth and the similarity score after the propagation and those before the propagation, and the changing of the spatial parameter of each pixel within the predetermined range based on the different classification conditions may further include:

First determining whether a current optimal estimate of the spatial parameter of the current pixel is obtained through propagation of adjacent pixels, and if the current optimal estimate of the spatial parameter of the current pixel is obtained through the propagation of adjacent pixels, comparing a current depth with a depth before propagation to determine whether a difference thereof exceeds a specified depth difference threshold; if the specified depth difference threshold is not exceeded, comparing a score of the spatial parameter of the current pixel with a score thereof before the propagation to determine whether a difference thereof exceeds a specified score difference threshold; and if the specified score difference threshold is exceeded and the score is better than the score before the propagation, that is, if the difference between the score after the propagation and the score before the propagation is large and the score after the propagation is better than the score before propagation, fluctuate the spatial parameter of the current pixel within the second predetermined range, that is, perform small-range fluctuating; in this case, since the score after the propagation reaches the preset threshold, the spatial parameter after the propagation is closer to the actual value, and thus only small-range fluctuating is necessary to estimate a spatial parameter value closer to the actual value; alternatively, if the specified score difference threshold is not exceeded, that is, if the difference between the score after the propagation and the score before the propagation is not large, randomly change the spatial parameter of the current pixel within the first predetermined range, and fluctuate the spatial parameter of the current pixel within the second predetermined range, that is, perform both large-range randomizing and small-range fluctuating, to find an estimate of the spatial parameter that is more in line with the actual value.

Still as shown in FIG. 4, the performing of the classification based on the differences in the depth and the similarity score after versus before the propagation, and the changing of the spatial parameter of each pixel within the predetermined range based on the different classification conditions may further include: determining whether a current optimal estimate of the spatial parameter of the current pixel is obtained through propagation of adjacent pixels, and if the current optimal estimate of the spatial parameter of the current pixel is not obtained through the propagation of adjacent pixels, comparing a depth of the current pixel with a depth before the propagation to determine whether a difference thereof exceeds a specified depth difference threshold; if the specified depth difference threshold is exceeded, comparing a score of the spatial parameter of the current pixel with a score thereof before the propagation to determine whether a difference thereof exceeds a specified score difference threshold; and if the specified score difference threshold is exceeded, randomly changing the spatial parameter of the current pixel within the first predetermined range, and fluctuating the spatial parameter of the current pixel within the second predetermined range; in this case, since it is impossible to definitely determine whether the depth after the propagation is closer to the actual value, both small-range fluctuating and large-range randomizing need to be performed, so as to find a better estimate of the spatial parameter; alternatively, if the specified score difference threshold is not exceeded, randomly changing the spatial parameter of the current pixel within the first predetermined range; in this case, since both the depth after the propagation and the depth before the propagation may deviate significantly from the actual value and that an estimate closer to the actual value may be hardly found through small-range fluctuating, large-range randomizing is selected to find an estimate closer to the actual value.

In an example, still as shown in FIG. 4, the performing of the classification based on the differences in the depth and the similarity score after versus before the propagation, and the changing of the spatial parameter of each pixel within the predetermined range based on the different classification conditions may further include: determining whether a current optimal estimate of the spatial parameter of the current pixel is obtained through the propagation of adjacent pixels, and if the current optimal estimate of the spatial parameter of the current pixel is not obtained through the propagation of adjacent pixels, comparing a depth of the current pixel with a depth before the propagation to determine whether a difference thereof exceeds a specified depth difference threshold; if the specified depth difference threshold is not exceeded, comparing a score of the spatial parameter of the current pixel with a score thereof before the propagation to determine whether a difference thereof exceeds a specified score difference threshold; and if the specified score difference threshold is exceeded, fluctuating the spatial parameter of the current pixel within the second predetermined range, in this case, since the score after the propagation differs significantly from the score before the propagation, which indicates that an estimate of the spatial parameter whose score reaches the preset threshold may be obtained through small-range fluctuating, small-range fluctuating may be selected; or if the specified score difference threshold is not exceeded, randomly changing the spatial parameter of the current pixel within the first predetermined range, and fluctuating the spatial parameter of the current pixel within the second predetermined range; in this case, since the difference between the two scores is not large, it is impossible to determine whether the depth after the propagation reaches the preset threshold, so both small-range fluctuating and large-range randomizing still need to be performed to find a better estimate of the spatial parameter.

Based on the current depth, score, depth of propagation, and score difference, the depth and the normal vector are selectively randomized within the large range and fluctuated within the small range, so as to reduce the amount of calculation and increase the calculation speed.

Further, still as shown in FIG. 1, step S104 is to update, based on a score of a changed spatial parameter of each pixel, spatial parameters of at least some pixels to spatial parameters whose scores reach a preset threshold.

The score of the changed spatial parameter of each pixel may be calculated by referring to the foregoing description. Based on this score, the spatial parameters of at least some pixels are updated to spatial parameters whose scores reach the preset threshold.

Specifically, the spatial parameter of each pixel may also be updated in a manner of changing within a predetermined range, that is, changing the spatial parameter of each pixel within the predetermined range, if a score obtained after the change reaches the preset threshold, for example, if a value of a matching cost becomes lower, updating the spatial parameter of the pixel to the changed spatial parameter. In some exemplary embodiments, the foregoing process may be further repeated. In addition, the change range may be reduced, until the spatial parameter of the pixel finally converges to a stable value, so that the value of the matching cost is minimized.

The foregoing manner of updating based on a spatial parameter of an adjacent pixel and the updating manner of changing within a predetermined range may be combined. To be specific, for each pixel, the manner of updating based on the spatial parameter of the adjacent pixel may be implemented first; then the updating manner of changing within the predetermined range is implemented; and after the spatial parameter of the pixel converges to a stable value, a spatial parameter of a next pixel is then updated.

Still as shown in FIG. 1, step S105 is to determine, based on an updated spatial parameter of each pixel in the reference image, a depth map corresponding to the reference image.

In some exemplary embodiments, the determining, based on the updated spatial parameter of each pixel in the reference image, the depth map corresponding to the reference image may include: after the spatial parameter of each pixel in the reference image converges to a stable value, determining, based on the spatial parameter of each pixel in the reference image, the depth map corresponding to the reference image.

Through the foregoing updating process, the updated spatial parameter of each pixel may be close to or reach the actual value. Therefore, an accurate per-pixel depth map may be obtained.

For any image in a two-dimensional image set, the foregoing manner may be used to obtain a depth map corresponding to the image. Thus, a dense point cloud image may be further generated based on the depth maps.

Further, the number of cycles of the foregoing steps may be set. For example, a target value of the quantity of cycles may be set based on a direction of propagation, until the number of cycles reaches the target value. In this case, the spatial parameter with the best score obtained by each pixel in these cycles may be regarded as close to or reaching the actual value. Therefore, an accurate per-pixel depth map can be obtained.

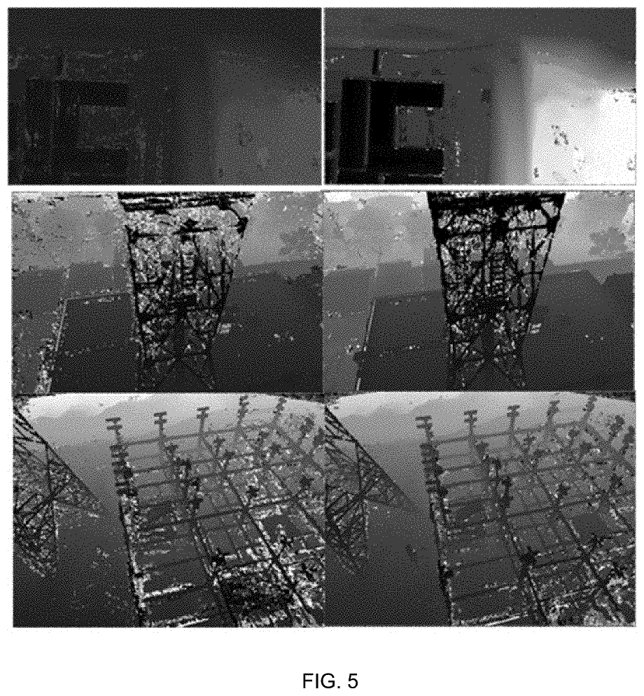

A result of image calculation using the foregoing method has significant improvements on both accuracy and the speed of point cloud generation. FIG. 5 is a schematic diagram showing a comparison between a depth map (right diagram) obtained by applying the method of the present disclosure in different scenarios and a depth map (left diagram) obtained by using a conventional method. As can be seen from the figure, in comparison with the conventional method, noise in the depth map obtained in some exemplary embodiments of the present disclosure is reduced, more depth points are calculated, and the depth map is more complete and accurate.

Still as shown in FIG. 1, step S106 is to generate a dense point cloud image based on the depth map corresponding to the reference image.

After the depth map corresponding to the image in the two-dimensional image set is obtained by performing the foregoing step, the dense point cloud image may be further generated based on the depth map. Depth maps corresponding to all images in the two-dimensional image set may be used, or depth maps corresponding to some images in the two-dimensional image set may be used. This is not limited in the present disclosure.

In some exemplary embodiments of the present disclosure, the dense point cloud image may be generated by fusing depth maps corresponding to a plurality of images in the two-dimensional image set. In some exemplary embodiments, the dense point cloud image may be generated by fusing depth maps corresponding to all images in the two-dimensional image set.

In some exemplary embodiments, before the dense point cloud image is generated, a blocked point and a redundant point may be removed.

Specifically, a depth value may be used to check whether a point is blocked, and if the point is blocked, this point should be removed. In addition, if two points are very close, it may be considered that this is caused by a calculation error. Actually, the two points may be the same point, thus one redundant point should be removed. After the redundant point is removed, the depth maps are fused to form a new dense point cloud image.

It should be understood that the manner of generating the dense point cloud image based on the depth map is not limited in the present disclosure. Alternatively, another manner may be used to generate the dense point cloud image based on the depth map.

Further, a three-dimensional map may be further generated based on the dense point cloud image.

The dense point cloud image may be further used to generate a three-dimensional map. A manner of generating the three-dimensional map based on the dense point cloud image is not limited in the present disclosure. In addition, when a spatial parameter includes a depth of a three-dimensional spatial point corresponding to a pixel and a normal vector of the three-dimensional spatial point, during generation of a three-dimensional map, a more accurate three-dimensional map may be further generated with reference to the normal vector of the three-dimensional spatial point.

In the foregoing method, the spatial parameter of each pixel after propagation is compared with that before the propagation to determine whether a change occurs, and if a change occurs, classification is performed based on the differences in the depth and the score after versus before the propagation, and the spatial parameter of each pixel is changed within the predetermined range based on different classification conditions. In this way, the amount of calculation is reduced, and the calculation speed is increased.

In addition, in the foregoing method, during score calculation, using the current pixel as a center, the image block is an image block in which a plurality of pixels spaced apart from each other by at least one pixel are selected around the current pixel. Therefore, the acquisition range of image blocks is expanded, and it is ensured that the detail effect is improved while the amount of calculation does not increase. Therefore, noise in the obtained depth map is reduced, more depth points are calculated, and the depth map is more complete and accurate. Moreover, correspondingly the point cloud image obtained by using the foregoing method also has less noise, more details can be displayed, and especially, there are more points in a textureless region.

The point cloud generation method in some exemplary embodiments of the present disclosure is described in detail above. The following describes a point cloud generation apparatus and system in some exemplary embodiments of the present disclosure in detail with reference to the accompanying drawings. The apparatus and system may generate a dense point cloud image based on a two-dimensional image set. Specifically, the apparatus and system may process the two-dimensional image set by using the technical solutions of some exemplary embodiments of the present disclosure, to generate a dense point cloud image.

FIG. 6 is a schematic block diagram of a point cloud generation apparatus 200 according to some exemplary embodiments of the present disclosure. The point cloud generation apparatus 200 may perform the point cloud generation method in the foregoing exemplary embodiments.

As shown in FIG. 6, the apparatus may include:

an initialization module 201, configured to initialize a spatial parameter of each pixel in a reference image, where the reference image may be any image in a two-dimensional image set obtained by photographing a target scene, and the spatial parameter may include at least a depth value and a normal vector of a three-dimensional spatial point corresponding to the pixel;

a propagation module 202, configured to update the spatial parameter of each pixel in the reference image by using propagation of adjacent pixels;

a changing module 203, configured to compare the spatial parameter of each pixel after propagation with that before the propagation to determine whether a change occurs, and if a change occurs, perform classification based on differences in a depth and a score before versus after the propagation, and change the spatial parameter of each pixel within a predetermined range based on different classification conditions;

an updating module 204, configured to update, based on a score of a changed spatial parameter of each pixel, spatial parameters of at least some pixels to spatial parameters whose scores reach a preset threshold;

a depth map generation module 205, configured to determine, based on an updated spatial parameter of each pixel in the reference image, a depth map corresponding to the reference image; and

a point cloud image generation module 206, configured to generate a dense point cloud image based on the depth map corresponding to the reference image.

By using the foregoing apparatus, the amount of calculation can be reduced, the calculation speed is increased, noise in the obtained depth map is reduced, more depth points are calculated, and the depth map is more complete and accurate. Correspondingly, the obtained point cloud image may have less noise, more details may be displayed, and especially, there are more points in a textureless region. Therefore, an accurate dense point cloud image may be obtained.

In an example, the initialization module is specifically configured to: generate a sparse point cloud image based on the two-dimensional image set; and initialize the spatial parameter of each pixel in the reference image based on the sparse point cloud image. In some exemplary embodiments, the initialization module may be specifically configured to generate the sparse point cloud image based on the two-dimensional image set by using a Structure from Motion method.

In an example, a direction of propagation of the spatial parameter of the pixel to adjacent pixels may include: from left to right of the reference image, and/or from right to left of the reference image; and from top to bottom of the reference image, and/or from bottom to top of the reference image.

The apparatus may further include a calculation module, configured to calculate the score, and specifically configured to project an image block around each pixel in the reference image to a neighboring image adjacent to the reference image, and calculate a similarity score of matched image blocks between the reference image and the neighboring image, where the image block with a current pixel as a center pixel is an image block in which a plurality of pixels spaced apart from the current pixel by at least one pixel are selected around the center pixel in the current image block.

In some exemplary embodiments, the plurality of pixels selected around the center pixel may be spaced apart from each other by at least one pixel.

In some exemplary embodiments, the calculation module may be more specifically configured to: calculate a selection probability; and perform the calculation of the similarity score by using the selection probability to weight a matching cost, where the selection probability is a probability that each pixel in the neighboring image appears in the reference image.

In some exemplary embodiments, the changing module 203 may be specifically configured to: if a current optimal estimate of a spatial parameter of a current pixel is obtained through propagation of adjacent pixels, compare a current depth with a depth before the propagation to determine whether a difference thereof exceeds a specified depth difference threshold; if the specified depth difference threshold is exceeded, compare a score of the spatial parameter of the current pixel with a score thereof before the propagation to determine whether a difference thereof exceeds a specified score difference threshold; and if the specified score difference threshold is exceeded and the score is better than the score before propagation, fluctuate the spatial parameter of the current pixel within the second predetermined range; or if the specified score difference threshold is not exceeded, randomly change the spatial parameter of the current pixel within the first predetermined range.

In some exemplary embodiments, the changing module 203 may be further specifically configured to: compare the current depth with the depth before the propagation to determine whether the difference thereof exceeds the specified depth difference threshold; if the specified depth difference threshold is not exceeded, compare a score of the spatial parameter of the current pixel with a score thereof before the propagation to determine whether a difference exceeds a specified score difference threshold; and if the specified score difference threshold is exceeded and the score is better than the score before the propagation, fluctuate the spatial parameter of the current pixel within the second predetermined range; or if the specified score difference threshold is not exceeded, randomly change the spatial parameter of the current pixel within the first predetermined range, and fluctuate the spatial parameter of the current pixel within the second predetermined range.

In some exemplary embodiments, the changing module 203 may be further specifically configured to: if a current optimal estimate of a spatial parameter of a current pixel is not obtained through the propagation of adjacent pixels, compare a depth of the current pixel with a depth before the propagation to determine whether a difference thereof exceeds a specified depth difference threshold; if the specified depth difference threshold is exceeded, compare a score of the spatial parameter of the current pixel with a score thereof before propagation to determine whether a difference exceeds a specified score difference threshold; and if the specified score difference threshold is exceeded, randomly change the spatial parameter of the current pixel within the first predetermined range, and fluctuate the spatial parameter of the current pixel within the second predetermined range; or if the specified score difference threshold is not exceeded, randomly change the spatial parameter of the current pixel within the first predetermined range.

In some exemplary embodiments, the changing module 203 may be further specifically configured to: compare the depth of the current pixel with the depth before propagation to determine whether the difference exceeds the specified depth difference threshold; if the specified depth difference threshold is not exceeded, compare the score of the spatial parameter of the current pixel with the score thereof before propagation to determine whether the difference exceeds the specified score difference threshold; and if the specified score difference threshold is exceeded, fluctuate the spatial parameter of the current pixel within the second predetermined range; or if the specified score difference threshold is not exceeded, randomly change the spatial parameter of the current pixel within the first predetermined range, and fluctuate the spatial parameter of the current pixel within the second predetermined range.

In some exemplary embodiments, the predetermined range may include a first predetermined range and a second predetermined range, an interval of the first predetermined range is greater than an interval of the second predetermined range, and the changing of the spatial parameter of each pixel within the predetermined range may include: randomly changing within the first predetermined range and/or fluctuating within the second predetermined range.

In some examples, the randomly changing of the spatial parameter of the current pixel within the first predetermined range may include:

keeping the depth of the current pixel unchanged, and randomly changing a normal vector thereof within the first predetermined range; and

keeping the normal vector of the current pixel unchanged, and randomly changing the depth thereof within the first predetermined range.

In some examples, the fluctuating of the spatial parameter of the current pixel within the second predetermined range may include:

keeping the depth of the current pixel unchanged, and fluctuating a normal vector thereof within the second predetermined range; and

keeping the normal vector of the current pixel unchanged, and fluctuating the depth thereof within the second predetermined range.

In some examples, as shown in FIG. 6, the depth map generation module 205 may be specifically configured to: after the spatial parameter of each pixel in the reference image converges to a stable value, determine, based on the spatial parameter of each pixel in the reference image, the depth map corresponding to the reference image.

In some examples, the point cloud image generation module 206 may be specifically configured to generate the dense point cloud image by fusing depth maps corresponding to all images in the two-dimensional image set.

In some exemplary embodiments, the apparatus 200 may further include a three-dimensional map generation module (not shown), configured to generate a three-dimensional map based on the dense point cloud image.

FIG. 7 is a schematic block diagram of a point cloud generation system 300 according to some exemplary embodiments of the present disclosure.

As shown in FIG. 7, the point cloud generation system 300 may include one or more processors 301, and one or more storage media, such as memories 302. In some exemplary embodiments, the point cloud generation system 300 may further include at least one of an input device (not shown), an output device (not shown), and an image sensor (not shown). These components may be interconnected through a bus system and/or a connection mechanism (not shown) in another form. It should be noted that the components and structure of the point cloud generation system 300 shown in FIG. 7 are only exemplary rather than restrictive. As needed, the point cloud generation system 300 may also have other components and structures, for example, may further include a transceiver configured to transmit and receive signals.

The memory 302 is a memory configured to store at least one set of instructions that can be executed by the processor, for example, configured to store an instruction for implementing corresponding steps and procedures of the point cloud generation method according to some exemplary embodiments of the present disclosure. The memory may include one or more computer program products, where the computer program product may include various forms of computer-readable storage media, for example, a volatile memory and/or a nonvolatile memory. The volatile memory may include, for example, a random access memory (RAM) and/or a cache. The nonvolatile memory may include, for example, a read-only memory (ROM), a hard disk, or a flash memory.

The input device may be a device used by a user to input an instruction, and may include one or more of a keyboard, a mouse, a microphone, a touchscreen, and the like.

The output device may output various information (for example, images or sounds) to outside (for example, a user), and may include one or more of a display, a speaker, and the like.

A communications interface (not shown) may be used by the point cloud generation system 300 for communication with another device, including wired or wireless communication. The point cloud generation system 300 may access a wireless network based on a communications standard, for example, Wi-Fi, 2G, 3G, 4G, 5G, or a combination thereof. In some exemplary embodiments, the communications interface may receive, through a broadcast channel, a broadcast signal or broadcast related information from an external broadcast management system. In some exemplary embodiments, the communications interface may further include a near field communication (NFC) module, to facilitate short range communication. For example, the NFC module may be implemented based on the radio frequency identification (RFID) technology, the Infrared Data Association (IrDA) technology, the ultra-wideband (UWB) technology, the Bluetooth (BT) technology, and other technologies.

The processor 301 may be a central processing unit (CPU), a graphics processing unit (GPU), an application-specific integrated circuit (ASIC), a field programmable gate array (FPGA), or a processing unit that is in another form and capable of data processing and/or instruction execution, and may control other components in the point cloud generation system 300 to perform desired functions. The processor may execute the instruction stored in the memory 302, to perform the point cloud generation method described in this disclosure. For example, the processor 301 may include one or more embedded processors, a processor core, a microprocessor, a logic circuit, a hardware finite state machine (FSM), a digital signal processor (DSP), or a combination thereof.

The computer-readable storage medium may store one or more computer program instructions of the aforementioned steps and/or methods. The processor 301 may execute the program instruction stored in the memory 302 to implement the functions, steps and/or methods (implemented by the processor) in some exemplary embodiments of the present disclosure and/or other expected functions, for example, to perform corresponding steps of the point cloud generation method according to some exemplary embodiments of the present disclosure, and may be configured to implement each module in the point cloud generation apparatus according to some exemplary embodiments of the present disclosure. The computer-readable storage medium may further store various application programs and various data, for example, various data used and/or generated by the application program.

In addition, some exemplary embodiments of the present disclosure may further provide a computer storage medium, where the computer storage medium stores a computer program. When the computer program is executed by a processor, the computer program may implement the steps of the point cloud generation method or the modules in the foregoing point cloud generation apparatus according to some exemplary embodiments of the present disclosure. For example, the computer storage medium may include, for example, a storage card of a smartphone, a storage component of a tablet computer, a hard disk of a personal computer, a read-only memory (ROM), an erasable programmable read-only memory (EPROM), a portable compact disc read-only memory (CD-ROM), a USB memory, or any combination of the foregoing storage media. The computer-readable storage medium may be one or any combination of a plurality of computer-readable storage media.

Although some exemplary embodiments have been described herein with reference to the accompanying drawings, it should be understood that these exemplary embodiments are merely exemplary, and are not intended to limit the scope of the present disclosure. A person of ordinary skill in the art may make various changes and modifications without departing from the scope of the present disclosure. All the changes and modifications are intended to be included in the scope of the present disclosure as claimed in the appended claims.

A person of ordinary skill in the art may be aware that the units and algorithm steps in the examples described with reference to the embodiments disclosed in this disclosure may be implemented by electronic hardware or a combination of computer software and electronic hardware. Whether the functions are performed by hardware or software depends on particular applications and design constraints of the technical solutions. A person skilled in the art may use different methods to implement the described functions for each particular application, but it should not be considered that the implementation goes beyond the scope of the present disclosure.

For the exemplary embodiments provided in this disclosure, it should be understood that the disclosed devices and methods may be implemented in other manners. For example, the described device exemplary embodiments are merely exemplary. For example, the unit division may be merely logical function division, and there may be other division in an actual implementation. For example, a plurality of units or components may be combined or integrated into another device, or some features may be omitted or may not be performed.

Although plenty of details are described in the specification provided herein, it can be understood that the embodiments of the present disclosure can be implemented without these specific details. In some examples, well-known methods, structures and technologies may not be shown in detail so as not to obscure the understanding of the present disclosure.

Similarly, it should be understood that, to simplify the present disclosure and help understand one or more of various aspects of the present disclosure, in the description of some exemplary embodiments of the present disclosure, various features of the present disclosure may be sometimes grouped together into a single embodiment, figure, or description thereof. However, the method of the present disclosure should not be construed as reflecting an intention that the claimed disclosure requires more features than the features set forth in each claim. More specifically, as reflected in the corresponding claims, the invention point(s) of the present disclosure lies in that corresponding technical problems can be resolved by using features fewer than all features of a single disclosed embodiment. Therefore, the claims following a specific implementation are thus explicitly incorporated into the specific implementation, and each claim itself may serve as a separate embodiment of the present disclosure.

A person skilled in the art can understand that, apart from mutual exclusion between the features, any type of combination may be used to combine all features disclosed in this specification (including the accompanying claims, abstract, and drawings) and all processes or units of any method or device disclosed in this manner. Unless otherwise explicitly described, each feature disclosed in this specification (including the accompanying claims, abstract and drawings) may be replaced by an alternative feature serving the same, equivalent or similar purpose.

In addition, a person skilled in the art can understand that although some exemplary embodiments described herein include certain features in other embodiments but not other features, a combination of features of different embodiments means that the features are within the scope of the present disclosure and form different embodiments. For example, in the claims, any one of the claimed embodiments may be used in any combination.

Some exemplary embodiments of the present disclosure may be implemented by hardware, or implemented by software modules running on one or more processors, or implemented by a combination thereof. A person skilled in the art should understand that, in practice, a microprocessor or a digital signal processor (DSP) may be used to implement some or all functions of some modules according to some exemplary embodiments of the present disclosure. The present disclosure may be further implemented as an apparatus program (for example, a computer program and a computer program product) configured to perform a part or an entirety of the method described herein. The program for implementing the present disclosure may be stored in a computer-readable medium, or may have one or a plurality of signal forms. Such signals may be downloaded from an Internet site, provided by a carrier signal, or provided in any other form.

It should be noted that the foregoing exemplary embodiments illustrate rather than limit the present disclosure and that a person skilled in the art may design alternative embodiments without departing from the scope of the appended claims. Any reference sign placed between parentheses in a claim shall not be construed as a limitation on the claim. The present disclosure can be implemented by hardware including several different elements, and by a suitably programmed computer. In unit claims enumerating several devices, some of the devices may be specifically embodied by the same hardware item. Use of the words “first”, “second”, “third”, and the like does not represent any sequence. These terms may be interpreted as names.

What is claimed is:

1. A point cloud generation method, comprising:
initializing a spatial parameter of each pixel in a reference image, wherein the reference image is an image in a two-dimensional image set obtained by photographing a target scene;
updating the spatial parameter of each pixel in the reference image through propagation of the spatial parameter of each pixel to adjacent pixels in the reference image to obtain an updated spatial parameter of the pixel in the reference image;
for each pixel in a reference image that a change of the spatial parameter occurs before and after the propagation:
determining a first difference between a depth value of the pixel before and after the propagation and a second difference between a score of the special parameter before and after the propagation;
performing classification based on the first difference and the second difference;
changing the spatial parameter of the pixel within a predetermined range based on the classification;
updating, based on the score of the updated spatial parameter of each pixel, spatial parameters of at least some pixels in the reference image to corresponding updated spatial parameters whose scores reach a preset threshold range;
determining, based on the updated spatial parameter of each pixel in the reference image, a depth map corresponding to the reference image; and
generating a dense point cloud image based on the depth map corresponding to the reference image.

2. The point cloud generation method according to claim 1, wherein the spatial parameter of the pixel includes at least a depth value and a normal vector of a three-dimensional spatial point corresponding to the pixel.

3. The point cloud generation method according to claim 1, wherein the preset threshold is in a positive correlation with the difference in the score.

4. The point cloud generation method according to claim 1, wherein the preset threshold is in a negative correlation with the difference in the score.

5. The point cloud generation method according to claim 1, wherein the score is obtained by:
projecting an image block around the pixel in the reference image to a neighboring image of the image set adjacent to the reference image; and
calculating a similarity score between the image block and a matched image block in the neighboring image,
wherein the image block is formed by a current pixel as a center pixel and a plurality of pixels spaced apart from the current pixel by at least one pixel selected in a current image block around the current pixel.

6. The point cloud generation method according to claim 5, wherein the plurality of pixels are spaced apart from each other by at least one pixel.

7. The point cloud generation method according to claim 5, wherein the calculating of the similarity score between the image block and the matched image block includes:
calculating a selection probability; and
calculating the similarity score by weighting a matching cost based on the selection probability, wherein
the selection probability is a probability of each pixel in the neighboring image appearing in the reference image.

8. The point cloud generation method according to claim 1, wherein the predetermined range includes a first predetermined range and a second predetermined range;
an interval of the first predetermined range is larger than an interval of the second predetermined range; and
the changing of the spatial parameter of the pixel within the predetermined range includes at least one of:
randomly changing the spatial parameter of the pixel within the first predetermined range, or
fluctuating the spatial parameter of the pixel within the second predetermined range.

9. The point cloud generation method according to claim 8, wherein the performing of the classification based on the first difference and the second difference and the changing of the spatial parameter of the pixel within the predetermined range based on the classification include:
determining that a current optimal estimate of a spatial parameter of a current pixel is obtained through the propagation of the spatial parameter of each pixel to the adjacent pixels; and
determine whether a difference between a current depth and a depth before the propagation exceeds a specified depth difference threshold.

10. The point cloud generation method according to claim 9, further comprising:
determining that the difference between the current depth and the depth before the propagation exceeds the specified depth difference threshold; and
determining whether a difference between the score of the spatial parameter of the current pixel and the corresponding score before the propagation exceeds a specified score difference threshold.

11. The point cloud generation method according to claim 10, further comprising:
determining that the difference between the score of the spatial parameter of the current pixel and the corresponding score before the propagation exceeds the specified score difference threshold and the score of the spatial parameter of the current pixel reaches the preset threshold range, and fluctuating the spatial parameter of the current pixel within the second predetermined range; or
determining that the difference between the score of the spatial parameter of the current pixel and the corresponding score before the propagation does not exceed the specified score difference threshold, and randomly changing the spatial parameter of the current pixel within the first predetermined range.

12. The point cloud generation method according to claim 9, wherein the performing of the classification based on the first difference and the second difference and the changing of the spatial parameter of the pixel within the predetermined range based on the classification further include:
determining that the difference between the current depth and the depth before the propagation does not exceed the specified depth difference threshold; and
determining whether a difference between the score of the spatial parameter of the current pixel and the corresponding score before the propagation exceeds a specified score difference threshold;
upon determining that the difference between the score of the spatial parameter of the current pixel and the corresponding score before the propagation exceeds the specified score difference threshold and the score of the spatial parameter of the current pixel reaches the preset threshold range, fluctuating the spatial parameter of the current pixel within the second predetermined range, or
upon determining that the difference between the score of the spatial parameter of the current pixel and the corresponding score before the propagation does not exceed the specified score difference threshold, randomly changing the spatial parameter of the current pixel within the first predetermined range and fluctuating the spatial parameter of the current pixel within the second predetermined range.

13. The point cloud generation method according to claim 8, wherein the performing of the classification based on the first difference and the second difference and the changing of the spatial parameter of the pixel within the predetermined range based on the classification further include:
determining that a current optimal estimate of a spatial parameter of a current pixel is not obtained through the propagation of adjacent pixels; and
determine whether a difference between a current depth and a depth before the propagation exceeds a specified depth difference threshold,
upon determining that the difference between the current depth and the depth before the propagation exceeds the specified depth difference threshold, determining whether a difference between the score of the spatial parameter of the current pixel and the corresponding score before the propagation exceeds a specified score difference threshold,
upon determining that the difference between the score of the spatial parameter of the current pixel and the corresponding score before the propagation exceeds the specified score difference threshold, randomly changing the spatial parameter of the current pixel within the first predetermined range, and fluctuating the spatial parameter of the current pixel within the second predetermined range, or
upon determining that the difference between the score of the spatial parameter of the current pixel and the corresponding score before the propagation does not exceed the specified score difference threshold, randomly changing the spatial parameter of the current pixel within the first predetermined range.

14. The point cloud generation method according to claim 13, wherein the performing of the classification based on the first difference and the second difference and changing of the spatial parameter of the pixel within the predetermined range based on the classification further include:
upon determining that the difference between the current depth and the depth before the propagation does not exceed the specified depth difference threshold, determining whether the difference between the score of the spatial parameter of the current pixel and the corresponding score before the propagation exceeds the specified score difference threshold; and
upon determining that the difference between the score of the spatial parameter of the current pixel and the corresponding score before the propagation exceeds the specified score difference threshold, fluctuating the spatial parameter of the current pixel within the second predetermined range, or
upon determining that the difference between the score of the spatial parameter of the current pixel and the corresponding score before the propagation does not exceed the specified score difference threshold, randomly changing the spatial parameter of the current pixel within the first predetermined range, and fluctuating the spatial parameter of the current pixel within the second predetermined range.

15. The point cloud generation method according to claim 8, wherein the first predetermined range includes a first predetermined range of depth and a first predetermined range of normal vector, and the randomly changing of the spatial parameter of the pixel within the first predetermined range includes:
keeping a depth of the pixel unchanged, and randomly changing a normal vector of the pixel within the first predetermined range of normal vector; and
keeping the normal vector of the pixel unchanged, and randomly changing the depth of the pixel within the first predetermined range of depth.

16. The point cloud generation method according to claim 8, wherein the second predetermined range includes a second predetermined range of depth and a second predetermined range of normal vector, and the fluctuating of the spatial parameter of the pixel within the second predetermined range includes:
keeping a depth of the pixel unchanged, and fluctuating a normal vector thereof within the second predetermined range of normal vector; and
keeping the normal vector of the pixel unchanged, and fluctuating the depth of the pixel within the second predetermined range of depth.

17. The point cloud generation method according to claim 1, wherein the initializing of the spatial parameter of the pixel in the reference image includes:
generating a sparse point cloud image based on the two-dimensional image set; and
initializing the spatial parameter of the pixel in the reference image based on the sparse point cloud image.

18. The point cloud generation method according to claim 17, wherein the generating of the sparse point cloud image based on the two-dimensional image set includes:
generating the sparse point cloud image based on the two-dimensional image set by using a Structure from Motion method.

19. The point cloud generation method according to claim 1, wherein a direction of the propagation of the spatial parameter of the pixel to adjacent pixels includes:
at least one of from left to right of the reference image, from right to left of the reference image, from top to bottom of the reference image, or from bottom to top of the reference image.

20. The point cloud generation method according to claim 1, wherein the determining, based on the updated spatial parameter of each pixel in the reference image, of the depth map corresponding to the reference image includes:
upon the spatial parameter of each pixel in the reference image converging to a stable value, determining, based on the spatial parameter of each pixel in the reference image, the depth map corresponding to the reference image.
